(19) United States
(12) Patent Application Publication
(10) Pub. No.: US 2023/0132213 A1
(43) Pub. Date: Apr. 27, 2023

(54) MANAGING BIAS IN FEDERATED LEARNING

(71) Applicant: Cisco Technology, Inc., San Jose, CA (US)

(72) Inventors: Myungjin Lee, Bellevue, WA (US); Ali Payani, Santa Clara, CA (US); Ramana Rao V.R. Kompella, Cupertino, CA (US)

(21) Appl. No.: 17/508,241

(22) Filed: Oct. 22, 2021

(51) Int. Cl. G06N 20/20

(52) U.S. Cl. CPC G06N 20/20

(57) ABSTRACT

In one embodiment, a device receives, from a plurality of training nodes that train a set of machine learning models using local training datasets, bias metrics associated with those machine learning models for each feature of the local training datasets. The device generates aggregated machine learning models over time that aggregate the machine learning models trained by the plurality of training nodes. The device constructs, based on the bias metrics, bias lineages for the aggregated machine learning models. The device provides, based on the bias lineages, a bias lineage for a particular one of the aggregated machine learning models for display.

### TECHNICAL FIELD

The present disclosure relates generally to computer networks, and, more particularly, to managing bias in federated learning.

### BACKGROUND

Machine learning is becoming increasingly ubiquitous in the field of computing. Indeed, machine learning is now used across a wide variety of use cases, from analyzing sensor data from sensor systems to performing future predictions for controlled systems. For instance, image recognition is a branch of machine learning dedicated to recognizing people and other objects in digital images.

Federated learning is a machine learning technique devoted to training a machine learning model in a distributed manner. This is in contrast to centralized training approaches, where training data is sent to a central location for model training. However, a drawback to federated learning is the potential for one or more of the learning nodes introducing bias into the machine learning model.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example of a federated learning system;

FIG. 4 illustrates an example architecture for a model training node in a federated learning system;

FIG. 5 illustrates an example architecture for a model aggregation node in a federated learning system;

FIG. 6 illustrates an example architecture for managing bias at a model aggregation node;

FIG. 7 illustrates an example of bias lineage information in a federated learning system; and

FIG. 8 illustrates an example simplified procedure for managing bias in a federated learning system.

### DESCRIPTION OF EXAMPLE EMBODIMENTS

### Overview

According to one or more embodiments of the disclosure, a device receives, from a plurality of training nodes that train a set of machine learning models using local training datasets, bias metrics associated with those machine learning models for each feature of the local training datasets. The device generates aggregated machine learning models over time that aggregate the machine learning models trained by the plurality of training nodes. The device constructs, based on the bias metrics, bias lineages for the aggregated machine learning models. The device provides, based on the bias lineages, a bias lineage for a particular one of the aggregated machine learning models for display.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

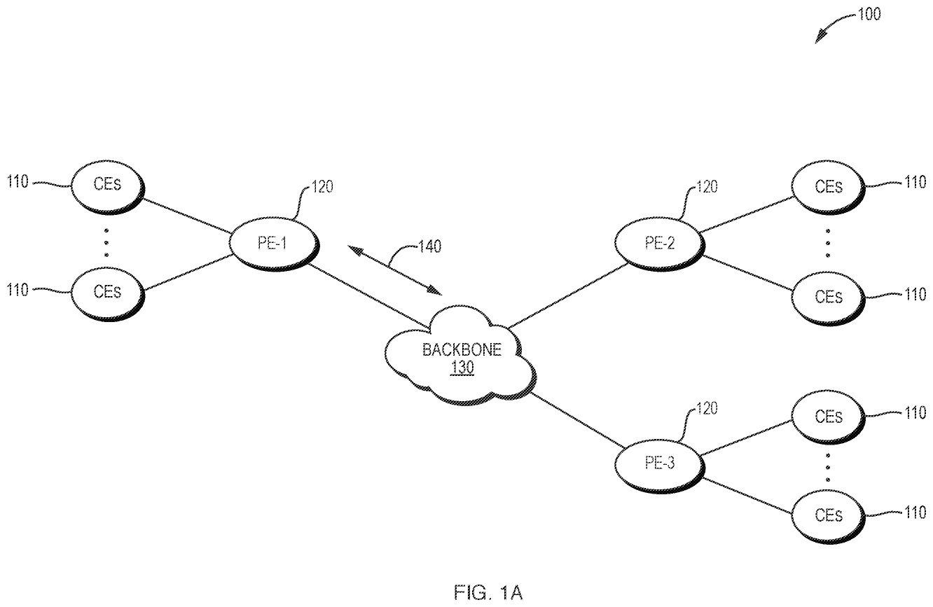

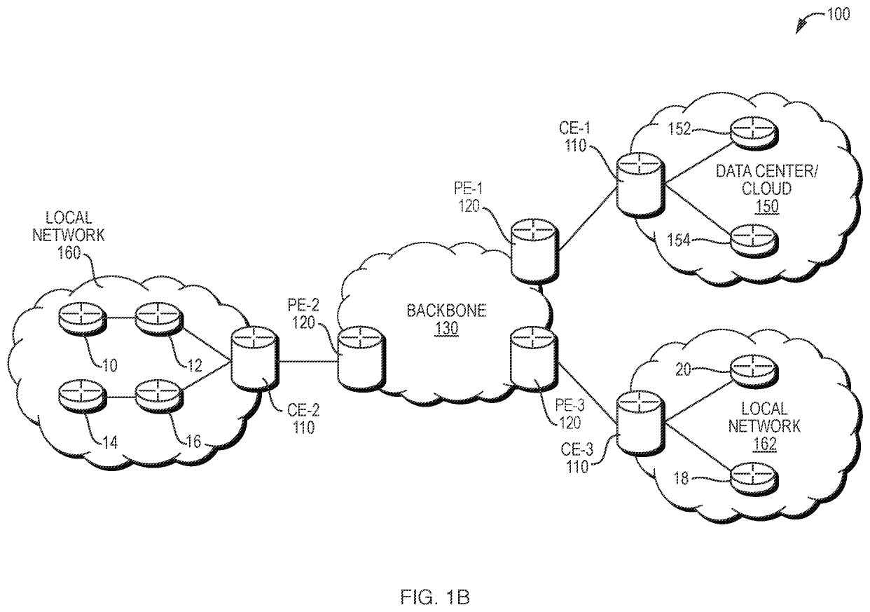

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

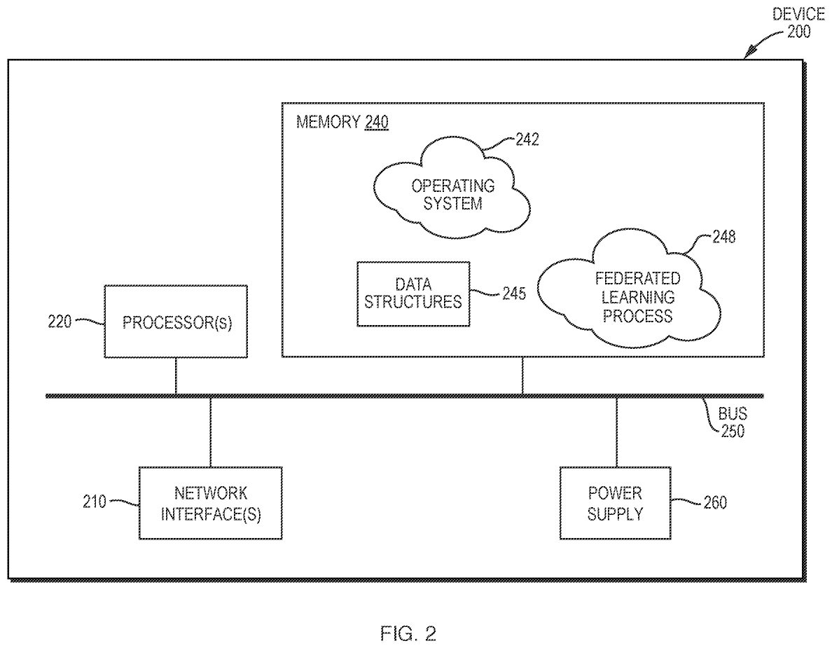

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a federated learning process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, federated learning process 248 may also include computer executable instructions that, when executed by processor(s) 220, cause device 200 to perform the techniques described herein. To do so, in various embodiments, federated learning process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data. As would be appreciated, this is an example of but one type of machine learning model (e.g., a linear regression model) and other types of models may also be used with the teachings herein.

In various embodiments, federated learning process 248 may employ, or be responsible for the deployment of, one or more supervised, unsupervised, or semi-supervised machine learning models. Generally, supervised learning entails the use of a training set of data, as noted above, that is used to train the model to apply labels to the input data. For example, the training data may include sample image data that has been labeled as depicting a particular condition or object. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that federated learning process 248 can employ, or be responsible for deploying, may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, consider the case of a model that classifies whether a particular image includes a certain object or not (e.g., a car, crosswalk, etc.). In such a case, the false positives of the model may refer to the number of times the model incorrectly determines that the object is present in an image, when it was not. Conversely, the false negatives of the model may refer to the number of times the model incorrectly determined that the object was not present in an image, but was actually present. True negatives and positives may refer to the number of times the model correctly determined that the object was not present or was present in an image, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in a federated learning setting, model training entails a diverse set of distributed nodes that each train machine learning models using their own training datasets, which are then aggregated into a global model. Typically, these distributed datasets are generated and managed by independent organizations and data owners. This is in contrast to centralized model training approaches that require the different nodes/organizations to transfer their training datasets to a central location for training.

In federated learning systems, the machine learning engineer(s) overseeing the federated learning system typically do not have direct access to the datasets. Consequently, it is very difficult, if not impossible, to verify the integrity of the various training datasets. Because of this, when the final model is built based on those distributed training datasets, the model can be corrupted due to data bias or feature bias in the datasets. Such bias can adversely impact user experience, lead to incorrect or misleading results, and other undesirable situations.

——Managing Bias in Federated Learning——

The techniques introduced herein allow for bias to be managed in a federated learning system. In some aspects, bias may be quantified during model training and tracked through bias lineages across models. In further aspects, the techniques herein also introduce mechanisms to eliminate or mitigate against bias, when detected.

Illustratively, the techniques described herein may be performed by hardware, software, and/or firmware, such as in accordance with federated learning process 248, which may include computer executable instructions executed by the processor 220 (or independent processor of interfaces 210) to perform functions relating to the techniques described herein.

Specifically, according to various embodiments, a device receives, from a plurality of training nodes that train a set of machine learning models using local training datasets, bias metrics associated with those machine learning models for each feature of the local training datasets. The device generates aggregated machine learning models over time that aggregate the machine learning models trained by the plurality of training nodes. The device constructs, based on the bias metrics, bias lineages for the aggregated machine learning models. The device provides, based on the bias lineages, a bias lineage for a particular one of the aggregated machine learning models for display.

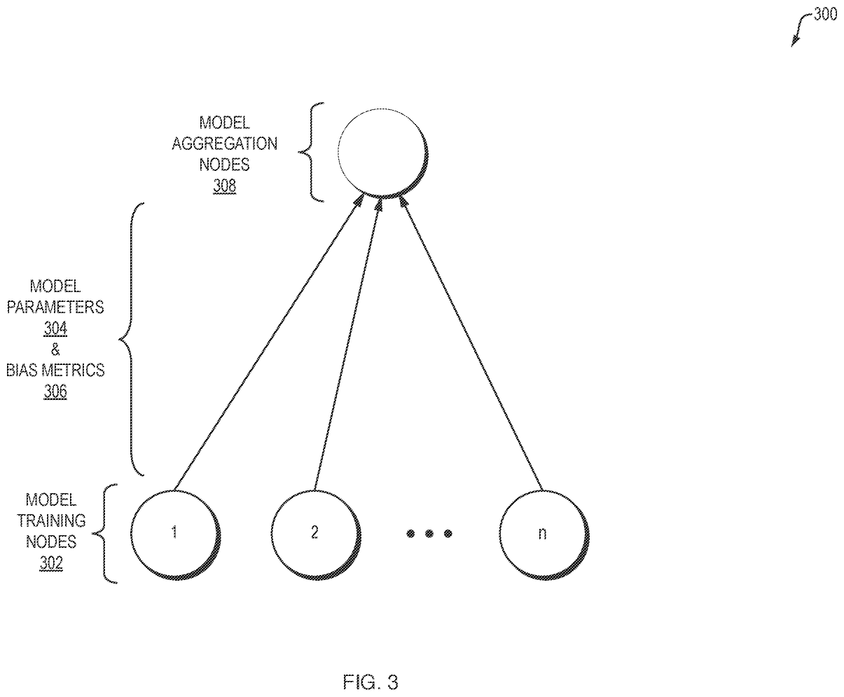

Operationally, FIG. 3 illustrates an example of a federated learning system 300, according to various embodiments. As shown, federated learning system 300 may include any number of model training nodes 302 (e.g., a first through nth training node), which are responsible for training machine learning models. Often times, model training nodes 302 correspond to devices located across any number of geographic areas.

In general, each of model training nodes 302 may maintain its own training dataset, locally. By way of example, consider the case of federated learning system 300 being used to train a machine learning model to detect a certain biomarker (e.g., a tumor, a broken bone, etc.) within medical image data. In such a case, each of model training nodes 302 may be devices located at different hospitals, universities, research institutions, etc., each of which maintains its own local training dataset of medical images. Typically, in some embodiments, the local training datasets of model training nodes 302 may remain local and not be shared with other nodes in federated learning system 300, thereby preserving the privacy of that data.

Once model training nodes 302 have trained their respective models using their own local data, they may send the model parameters 304 for these models to a model aggregation node 308. In turn, node 308 may use model parameters 304 to aggregate the models into an aggregate/global model. By doing so, the aggregate model may be based on a very robust set of training data, when compared to any of the models trained by model training nodes 302, individually. In addition, this allows the underlying training data to be protected from being exposed or transferred from their respective locations.

The training process itself may also be iterative between model aggregation node 308 and model training nodes 302, in some embodiments. For instance, once model aggregation node 308 has generated an aggregated model from the models computed by model training nodes 302, it may send that aggregated model back to model training nodes 302. This allows model training nodes 302 to use the aggregated model as a basis for their next round of training. This may be repeated any number of times, until an aggregated model is deemed finalized.

Note that the topology of federated learning system 300 is exemplary only, and that other topologies are also possible. For instance, in further instances, model aggregation node 308 may be one of multiple model aggregation node 308, each of which receives model parameters 304 from one or more model training nodes 302. A higher level model aggregation node may then receive model parameters for the aggregated models, such as those generated by model aggregation node 308.

According to various embodiments, for each round of training by model training nodes 302, they may also compute bias metrics 306 for their respective models. These bias metrics may be based on user-provided functions or using a pre-built mechanism. In various embodiments, bias metrics 306 may also be computed on a per-data feature basis. For example, model training nodes 302 may compute bias metrics 306 by computing the true positives, true negatives, false positives, and false negatives for each sub-population corresponding to each of the sensitive features or attributes used during training (e.g., male vs. female, age 30-40 vs. 50-60, etc.), by applying their trained models to a validation dataset. In turn, bias metrics 306 may be represented as a confusion matrix for that sub-population. Of course, other bias computation approaches could also be used.

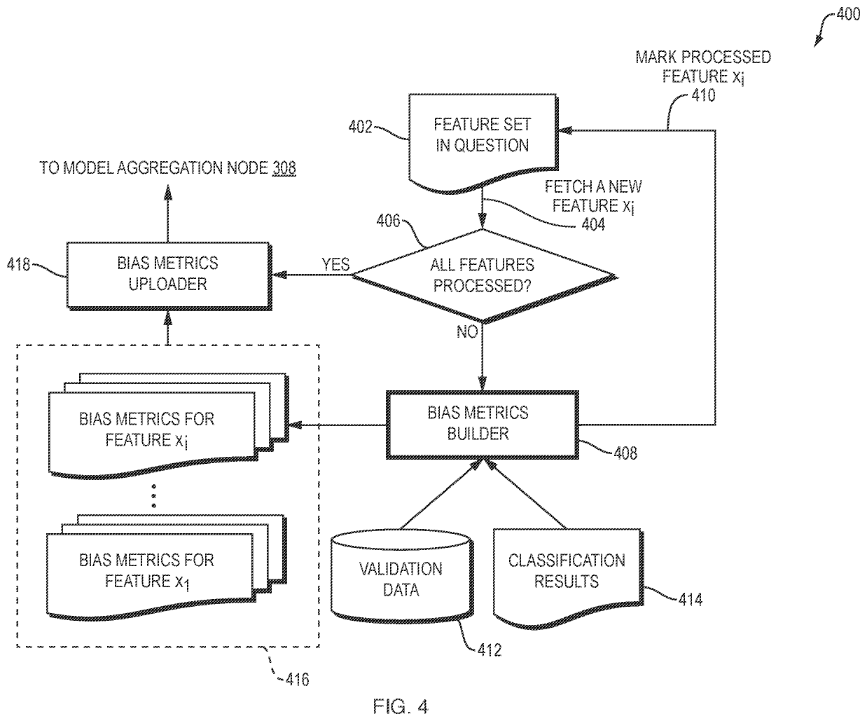

FIG. 4 illustrates an example architecture 400 for a model training node in a federated learning system, according to various embodiments. For instance, any of model training nodes 302 may be implemented in accordance with architecture 400. In general, architecture 400 may be implemented through the execution of the following sub-components: a bias metrics builder 408 and a bias metrics uploader 418 (e.g., as sub-components of its federated learning process 248). As would be appreciated, the functionalities of bias metric builder 408 and bias metrics uploader 418 may be combined or omitted, as desired.

As shown, assume that the model training node has a feature set 402 (e.g., a training dataset) with which it is to train a model. To determine the amount of bias for each of those features, it may execute a bias metric builder 408 that iteratively evaluates each of the features of feature set 402.

More specifically, assume that there are k-number of features in feature set 402. In such a case, bias metric builder 408 may fetch feature 404 (e.g., feature xᵢ) and use its trained model against validation data 412 (e.g., a portion of its dataset not used for training). Based on the classification results 414 from this, the node may compute the bias metrics for that feature. In turn, the node may apply a flag/mark 410 to the data feature and fetch a new feature for processing (e.g., feature xᵢ₊₁).

During each round of processing, the training node may make a decision 406 as to whether there are any features in feature set 402 that still need to be processed. In other words, bias metric builder 408 may evaluate each of the features in feature set 402, until it has constructed a complete set 416 of bias metrics for each of the features associated with its trained model. Once this happens, the node may signal to bias metrics uploader 418 that the set 416 of bias metrics is ready to be reported to its model aggregation node, such as model aggregation node 308, described previously.

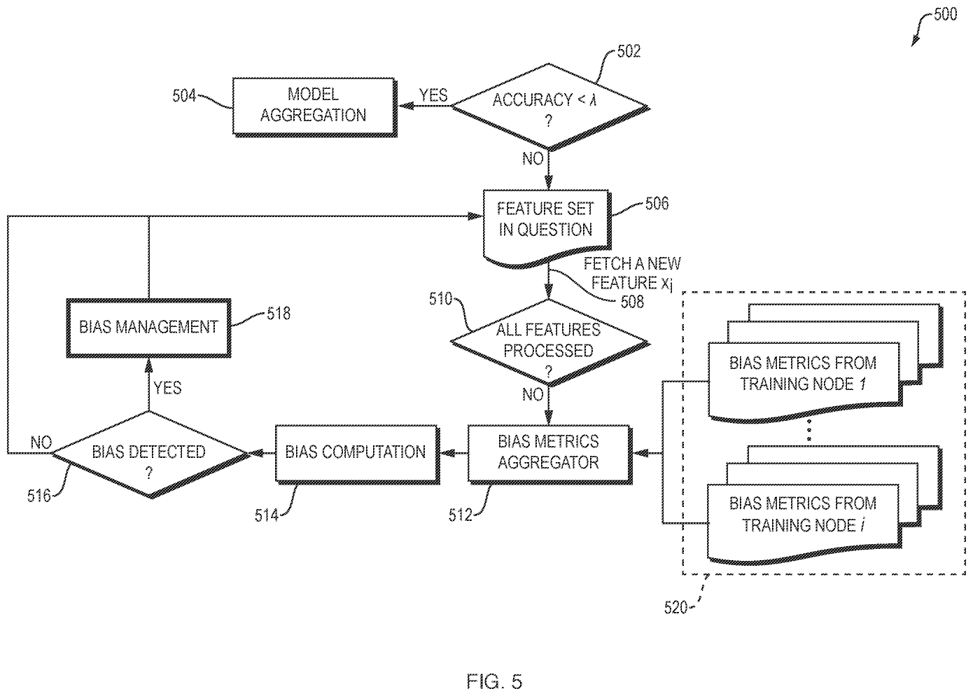

FIG. 5 illustrates an example architecture 500 for a model aggregation node in a federated learning system, according to various embodiments. For instance, model aggregation node 308 in FIG. 3 may be implemented in accordance with architecture 500. At the core of architecture 500 is a model aggregation sub-process 504, a bias metric aggregator sub-process 512, a bias computation sub-process 514, and/or a bias management sub-process 518, each of which may be a sub-component of the federated learning process executed by the model aggregation node (e.g., federated learning process 248) or another process that operates in conjunction therewith. The functionalities of these sub-components may be combined or omitted, as desired.

In general, model aggregation sub-process 504 may be configured to aggregate the machine learning models from the model training nodes associated with the aggregation node into an aggregated model. To do so, model aggregation sub-process 504 may use the model parameters (e.g., model parameters 304) from each of the models trained by the model training nodes, to form an aggregated model.

In some embodiments, the model aggregation node may make a comparison 502 between the accuracy of its aggregated model and a threshold accuracy. To determine the accuracy, the model aggregation node may use its aggregated model to classify a validation dataset and use the results to compute the accuracy of that model.

If the accuracy is less than a certain threshold, this means that the provided model is not very efficient. In such a case, mitigating bias still does not guarantee that the resulting model will exhibit acceptable accuracy. Thus, in this instance, the model aggregation node may simply perform model aggregation 504 on the model.

However, if the accuracy of the aggregated model is greater than, or equal to, the defined threshold, the model has acceptable accuracy and the model aggregation node may begin evaluating and mitigating any bias associated with that model. To do so, the node may begin by evaluating the feature set 506 in question, iteratively evaluating each of the features on an individual basis. More specifically, the aggregation node may fetch a new feature 508 from set 506 and make a determination 510 as to whether all features in set 506 have already been processed.

If a feature still needs to be processed, bias metrics aggregator 512 may then aggregate the various sets 520 of bias metrics for that feature that the aggregation node received from its various model training nodes. Such bias metrics may be computed by each of the model training nodes in accordance with architecture 400 in FIG. 4, in some embodiments.

In turn, bias computation sub-process 514 may use the aggregated bias metrics for a given feature across the different model training nodes, to determine whether there is bias present for that feature. The aggregation node may then make a determination 516 as to whether the computation by bias computation sub-process 514 indicates the presence of bias for that feature. If not, the node may continue on to the next feature.

However, in various embodiments, if the aggregation node determines that there is bias present for a particular feature, it may leverage bias management sub-process 518 to mitigate against such bias.

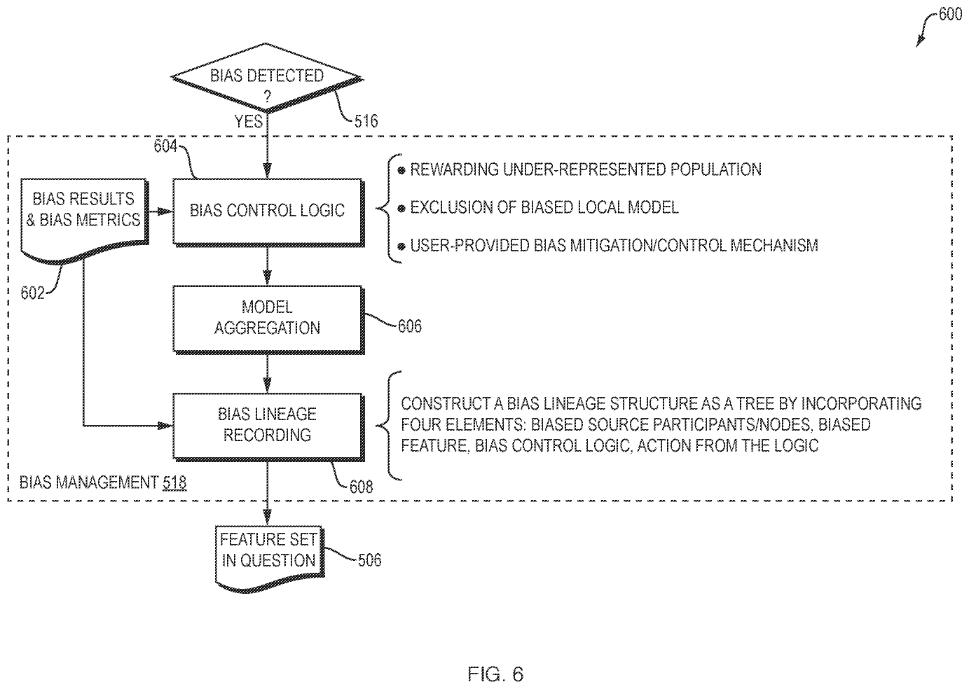

FIG. 6 illustrates an example architecture 600 for managing bias at a model aggregation node, according to various embodiments. For instance, architecture 600 may be used to implement bias management sub-process 518 shown previously in FIG. 5. Generally, architecture 600 includes three main components: bias control logic 604, a model aggregation module 606, and a bias lineage recording module 608, in various embodiments.

When the aggregation node makes a determination 516 that there is bias present in a particular feature, it may input the bias results and bias metrics 602 computed by bias computation sub-process 514, previously, to bias control logic 604. In various embodiments, the function of bias control logic 604 is to determine how to deal with the detected bias. In one embodiment, this can be done by examining which bias metrics (e.g., ones from individual training nodes) contributed to bias metrics 602. In turn, bias control logic 604 may exclude the local models from being used to generate an aggregated/global model. In another embodiment, bias control logic 604 may reward an underrepresented population in the feature set when the aggregated model is generated (e.g., by increasing their importance/weights, etc.). In yet another embodiment, bias control logic 604 may implement a user-provided bias mitigation/control mechanism, such as by asking an engineer how to proceed, take automatic actions, or the like.

Model aggregation module 606 is responsible for generating aggregated machine learning models, in accordance with the decisions made by bias control logic 604. For simplicity, model aggregation module 606 is shown as part of bias management sub-process 518. However, in some implementations, model aggregation module 606 may be a separate sub-process that operates in conjunction with bias management sub-process 518 (e.g., bias management sub-process 518 may simply make calls to model aggregation sub-process 504, shown previously in FIG. 5).

According to various embodiments, bias lineage recording module 608 is responsible for constructing bias lineages for the aggregated models generated by model aggregation module 606. For instance, bias lineage recording module 608 may record the bias results, bias metrics, the signature of bias control logic 604 (e.g., an SHA1 hash value of logic codes), the action taken by bias control logic 604 (e.g., excluding certain model data/training nodes from being used, etc.), an input model version used for building a new model version (e.g., the new aggregated/global model from model aggregation module 606), combinations thereof, or the like.

Then, after the bias management process is carried out for all features, the global model may be distributed to the training nodes, and they proceed to the next round of training. Consequently, the model aggregation node may generate a series of aggregated models over time, which it then shares back to the individual model training nodes on which they may base their next model versions.

The resulting bias lineage data recorded by bias lineage recording module 608 allows for the tracking of the biases across the different model versions over time. In turn, the aggregation node may provide such lineage data for display, allowing a user to review the source(s) of bias for a particular version of an aggregated model. This allows the user to better assess the biases across the models for debugging purposes. In one embodiment, the user may even opt to roll back the aggregated machine learning model to a prior version, based on the bias lineage for the current model.

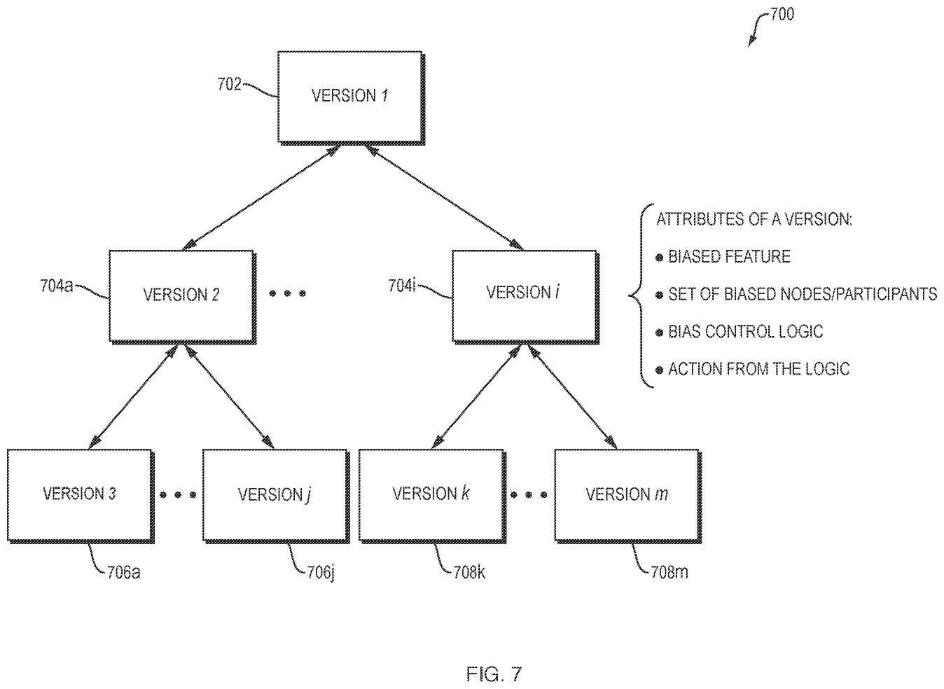

In some embodiments, bias lineage recording module 608 may store the bias lineages using a tree-shaped data structure, where each node in the data structure represents a model version. FIG. 7 illustrates an example of such a tree-shaped data structure 700. As shown, each node in data structure 700 may correspond to a different version of a machine learning model.

In various embodiments, parent-child relationships between nodes/versions in data structure 700 may indicate the version of the machine learning model from which a particular version is derived. For instance, node 702 may represent a base model from which version 2 through version i were derived, as represented by nodes 704a-704i. Similarly, versions 3-j of the model may be derived from version 2, as represented by nodes 706a-706j, while versions k-m of the model may be derived from version i, as represented by nodes 708k-708m.

Each node in data structure 700 may also have associated attributes, in various embodiments. For instance, a given node representing a particular version of an aggregated machine learning model may be associated with an indication of its biased feature(s), the nodes/participants in its training that are responsible for that bias, the bias control logic applied when generating the model, any actions taken by the control logic, combinations thereof, or the like.

As a result of data structure 700 being populated, a user (e.g., a machine learning engineer) is now able to review the bias lineage for any given version of the aggregated machine learning model. For instance, data structure 700 may be traversed to inform the user that version 3 of the model was derived from version 2, which itself was derived from version 1, as well as the bias information for each of those models. This allows the user to better assess how any bias was introduced, any corrective measures taken along the way by the bias control logic, etc.

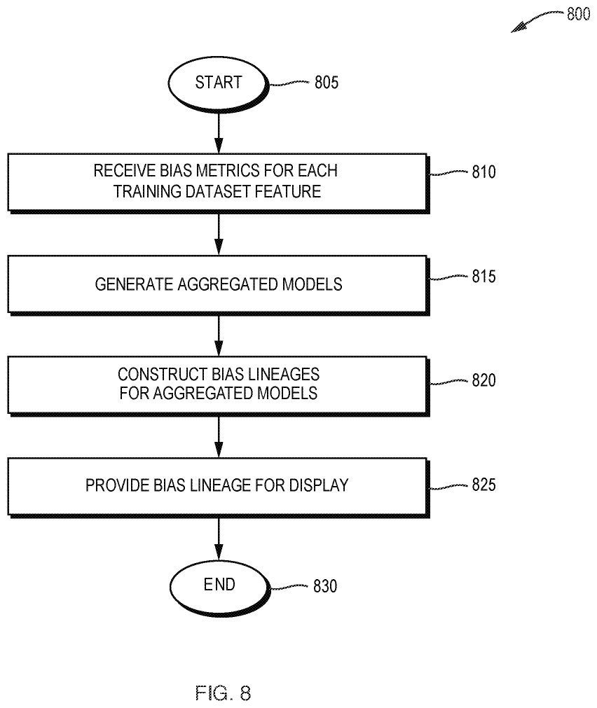

FIG. 8 illustrates an example simplified procedure 800 (e.g., a method) for managing bias in a federated learning system, in accordance with one or more embodiments described herein. For example, a non-generic, specifically configured device (e.g., device 200), may perform procedure 800 by executing stored instructions (e.g., federated learning process 248). The procedure 800 may start at step 805, and continues to step 810, where, as described in greater detail above, the device may receive, from a plurality of training nodes that train a set of machine learning models using local training datasets, bias metrics associated with those machine learning models for each feature of the local training datasets. In some embodiments, the plurality of training nodes are located across a plurality of different geographic locations. In further embodiments, the nodes in the plurality of training nodes do not transfer their local training datasets to the device.

At step 815, as detailed above, the device may generate aggregated machine learning models over time that aggregate the machine learning models trained by the plurality of training nodes. To do so, in some embodiments, the device may use received parameters for the set of machine learning models, to generate aggregated machine learning models based on those parameters. In further embodiments, the device may do so in part by excluding a machine learning model from a particular one of the plurality of training nodes from being used to generate one of the aggregated machine learning models, based on a determination that the bias metrics from that particular training node exceed a threshold.

At step 820, the device may construct, based on the bias metrics, bias lineages for the aggregated machine learning models, as described in greater detail above. In one embodiment, the bias lineage for the particular one of the aggregated machine learning models indicates at least one of the local training datasets as a source of bias for a data feature used by that aggregated machine learning model. In another embodiment, the bias lineage for the particular one of the aggregated machine learning models indicates a version of at least one machine learning model on which it is based. In a further embodiment, the bias lineage further indicates which of the plurality of training nodes associated with the at least one machine learning model on which the particular one of the aggregated machine learning models is based. In yet another embodiment, the bias lineage indicates that the machine learning model from the particular one of the plurality of training nodes was excluded from being used to generate one of the aggregated machine learning models.

At step 825, as detailed above, the device may provide, based on the bias lineages, a bias lineage for a particular one of the aggregated machine learning models for display. In some embodiments, the device may also roll back the particular one of the aggregated machine learning models to a prior version, in response to a request to do so from a user interface, based in part on the bias lineage for the particular one of the aggregated machine learning models. Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for the management of bias in a federated learning system, it is to be understood that various other adaptations and modifications may be made within the spirit and scope of the embodiments herein. For example, while certain embodiments are described herein with respect to certain to certain topologies for a federated learning system, other topologies may be used, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
receiving, at a device and from a plurality of training nodes that train a set of machine learning models using local training datasets, bias metrics associated with those machine learning models for each feature of the local training datasets;
generating, by the device, aggregated machine learning models over time that aggregate the machine learning models trained by the plurality of training nodes;
constructing, by the device and based on the bias metrics, bias lineages for the aggregated machine learning models; and
providing, by the device and based on the bias lineages, a bias lineage for a particular one of the aggregated machine learning models for display.

2. The method as in claim 1, wherein the plurality of training nodes are located across a plurality of different geographic locations.

3. The method as in claim 1, wherein generating the aggregated machine learning models over time comprises:
receiving, from the plurality of training nodes, parameters for the set of machine learning models, wherein the device generates the aggregated machine learning models based on those parameters.

4. The method as in claim 1, wherein the bias lineage for the particular one of the aggregated machine learning models indicates at least one of the local training datasets as a source of bias for a data feature used by that aggregated machine learning model.

5. The method as in claim 1, wherein the plurality of training nodes do not transfer their local training datasets to the device.

6. The method as in claim 1, wherein the bias lineage for the particular one of the aggregated machine learning models indicates a version of at least one machine learning model on which it is based.

7. The method as in claim 6, wherein the bias lineage further indicates which of the plurality of training nodes associated with the at least one machine learning model on which the particular one of the aggregated machine learning models is based.

8. The method as in claim 1, wherein generating the aggregated machine learning models over time comprises:
excluding a machine learning model from a particular one of the plurality of training nodes from being used to generate one of the aggregated machine learning models, based on a determination that the bias metrics from that particular training node exceed a threshold.

9. The method as in claim 8, wherein the bias lineage indicates that the machine learning model from the particular one of the plurality of training nodes was excluded from being used to generate one of the aggregated machine learning models.

10. The method as in claim 1, further comprising:
rolling back the particular one of the aggregated machine learning models to a prior version, in response to a request to do so from a user interface, based in part on the bias lineage for the particular one of the aggregated machine learning models.

11. An apparatus, comprising:
one or more network interfaces;
a processor coupled to the one or more network interfaces and configured to execute one or more processes; and
a memory configured to store a process that is executable by the processor, the process when executed configured to:
receive, from a plurality of training nodes that train a set of machine learning models using local training datasets, bias metrics associated with those machine learning models for each feature of the local training datasets;
generate aggregated machine learning models over time that aggregate the machine learning models trained by the plurality of training nodes;
construct, based on the bias metrics, bias lineages for the aggregated machine learning models; and
provide, based on the bias lineages, a bias lineage for a particular one of the aggregated machine learning models for display.

12. The apparatus as in claim 11, wherein the plurality of training nodes are located across a plurality of different geographic locations.

13. The apparatus as in claim 11, wherein generating the aggregated machine learning models over time by:
receiving, from the plurality of training nodes, parameters for the set of machine learning models, wherein the apparatus generates the aggregated machine learning models based on those parameters.

14. The apparatus as in claim 11, wherein the bias lineage for the particular one of the aggregated machine learning models indicates at least one of the local training datasets as a source of bias for a data feature used by that aggregated machine learning model.

15. The apparatus as in claim 11, wherein the plurality of training nodes do not transfer their local training datasets to the apparatus.

16. The apparatus as in claim 11, wherein the bias lineage for the particular one of the aggregated machine learning models indicates a version of at least one machine learning model on which it is based.

17. The apparatus as in claim 16, wherein the bias lineage further indicates which of the plurality of training nodes associated with the at least one machine learning model on which the particular one of the aggregated machine learning models is based.

18. The apparatus as in claim 11, wherein the apparatus generates the aggregated machine learning models over time by:
excluding a machine learning model from a particular one of the plurality of training nodes from being used to generate one of the aggregated machine learning models, based on a determination that the bias metrics from that particular training node exceed a threshold.

19. The apparatus as in claim 18, wherein the bias lineage indicates that the machine learning model from the particular one of the plurality of training nodes was excluded from being used to generate one of the aggregated machine learning models.

20. A tangible, non-transitory, computer-readable medium storing program instructions that cause a device to execute a process comprising:
receiving, at the device and from a plurality of training nodes that train a set of machine learning models using local training datasets, bias metrics associated with those machine learning models for each feature of the local training datasets;
generating, by the device, aggregated machine learning models over time that aggregate the machine learning models trained by the plurality of training nodes;
constructing, by the device and based on the bias metrics, bias lineages for the aggregated machine learning models; and
providing, by the device and based on the bias lineages, a bias lineage for a particular one of the aggregated machine learning models for display.
